(19) United States
(12) Patent Application Publication
(10) Pub. No.: US 2014/0021717 A1
(43) Pub. Date: Jan. 23, 2014

(54) PIPE CONNECTOR ASSEMBLY

(71) Applicants: Paul Burke, Commerce, MI (US); Mitchell Wayne Hunt, Durand, MI (US)

(72) Inventors: Paul Burke, Commerce, MI (US); Mitchell Wayne Hunt, Durand, MI (US)

(21) Appl. No.: 13/552,241

(22) Filed: Jul. 18, 2012

(51) Int. Cl. F16L 37/08; B23P 11/00

(52) U.S. Cl. 285/321; 29/428

(57) ABSTRACT

A connector assembly for establishing fluid communication between a copper pipe and a cross-linked polyethylene (PEX) tube is provided. The connector assembly additionally includes a retainer including a plurality of teeth. In operation, the copper tube is inserted into a female receiving portion of the housing and a fluid-tight seal is established therebetween. Then, a PEX expansion ring is expanded radially outwardly and inserted over the retainer and contracted to urge the teeth against the copper pipe, thereby retaining the copper pipe inside of the housing. Next, an end of the PEX tube and another expansion ring are expanded radially outwardly and inserted over the male end form of the housing. This PEX expansion ring then contracts to establish a fluid-tight seal between the PEX tube and the male end form of the housing.

### BACKGROUND OF THE INVENTION

1. Field of the Invention

The present invention is related to connector assemblies for fluidly connecting pipes or tubes of different materials to one another.

2. Description of the Prior Art

The plumbing systems of most buildings in the United States include one or more of copper, chlorinated polyvinyl chloride (CPVC) and/or cross-linked polyethylene (PEX) pipes or tubes. Many plumbers prefer to work with PEX over the other materials because of PEX's flexibility, low-cost, corrosion-resistance and resistance to bursting from freezing. Such plumbers often require an adapter or connector assembly to fluidly connect their PEX tubing to a building's existing copper or CPVC piping system. Some pipe manufacturers produce copper or CPVC to PEX adapters for serving this purpose. However, many of these adapter designs are costly, laborious to install (for example, some designs require adhesives or welding) or unreliable. There remains a significant and continuing need for an improved connector assembly which overcomes the disadvantages associated with other known adapters.

### SUMMARY OF THE INVENTION

According to one aspect of the present invention, a connector assembly is provided for establishing fluid communication between a pipe (such as a copper pipe) and a tube of an expandable material (such as a PEX tube). The connector assembly includes a housing which extends along an axis between a female receiving portion for receiving the pipe and a male end form for mating with the tube. The housing presents an exterior surface and an inner bore and includes at least one aperture which extends in a radial direction from the exterior surface to the inner bore. A retainer extends at least partially around the perimeter of the exterior surface of the housing and includes a plurality of teeth which extend radially inwardly. The retainer is of a spring-like material and is deflectable in a radially inward direction from a non-engaged position to an engaged position for retaining the pipe in the inner bore in response to an expansion ring contracting about the retainer. This unique construction is advantageous because it may be assembled cost effectively and also provides for a quick, secure and fluid-tight connection between the pipe and tube as compared to other known connector assemblies or adapters. Additionally, the connector assembly does not require the use of any adhesives or welding which are required in other known adapters. Even further, depending on the material that the housing is formed of, the compression of the expansion ring and PEX tube about the housing may additionally compress the housing and O-ring against the copper pipe to form a stronger seal between the copper pipe and the housing.

According to another aspect of the present invention, the housing of the connector assembly is constructed of two pieces: an outer housing portion and an inner housing portion. The outer housing portion includes a first shoulder which faces towards the female receiving portion of the housing, and the inner housing portion is nested within the outer housing portion. The end of the inner housing portion is spaced axially from the first shoulder to provide a ring groove in the inner bore of the housing. An O-ring seal is disposed in the ring groove to establish a fluid-tight seal between the pipe and the housing. This unique construction may provide advantages in the manufacturability of the connector assembly.

According to yet another aspect of the present invention, the inner and outer housing portions are properly oriented relative to one another through a rib and groove connection. Specifically, one of the housing portions includes at least one rib and the other includes at least one groove. The inner housing portion can only be inserted into the outer housing portion by aligning the rib with the groove, thus ensuring that the inner housing portion is properly oriented relative to the outer housing portion during assembly. In other words, the rib and groove connection is a poka-yoke feature which ensures that these components can only be put together correctly.

According to still another aspect of the present invention, a method of establishing a fluid communication between a pipe and a tube of an expandable material with a connector assembly having a housing and a retainer with a plurality of teeth is provided. The method includes the step of inserting the pipe into one end of the housing. The method proceeds with the step of expanding an end of the tube. Next, the method includes the step of inserting the side of the housing opposite of the pipe into the expanded end of the tube. The method then continues with the step of contracting the end of the tube onto the housing and the retainer to engage the teeth of the retainer onto the pipe to hold the pipe in the housing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective and elevation view of an exemplary connector assembly attached to and establishing fluid communication between a copper pipe and a PEX tube;

FIG. 2 is a perspective and elevation view of the exemplary connector assembly of FIG. 1 shown without the copper pipe or PEX tube;

FIG. 3 is a front view of the exemplary connector assembly of FIG. 2;

FIG. 4 is an exploded view of the exemplary connector assembly of FIGS. 2; and

FIG. 5 is a cross-sectional view of the exemplary connector assembly taken along line 5-5 of FIG. 1.

### DESCRIPTION OF THE ENABLING EMBODIMENT

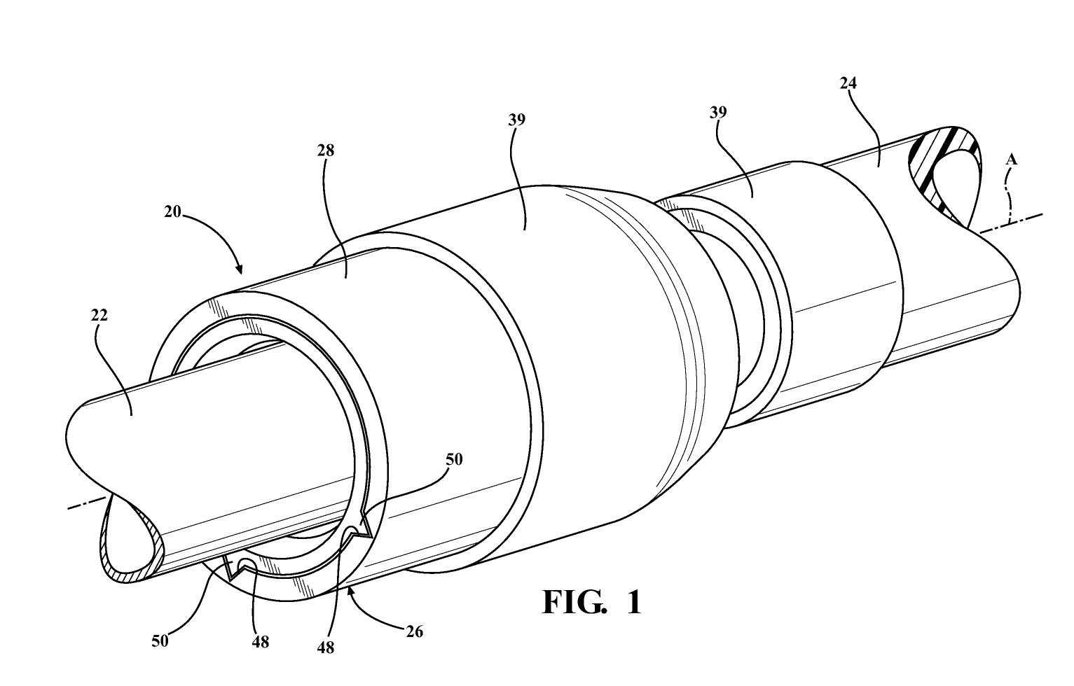

Referring to the Figures, wherein like numerals indicate corresponding parts throughout the several views, a connector assembly 20 is shown in fluid connection with a pipe 22 and a tube 24 of an expandable material in FIG. 1. In the exemplary embodiment, the pipe 22 is of copper and the tube 24 is of a cross-linked polyethylene (PEX) material. As such, the exemplary connector assembly 20 may find uses in the plumbing systems of many residential or commercial buildings by serving as a bridge between the existing copper pipe 22 of a building and a PEX tubing system. However, it should be appreciated that the pipe 22 and tube 24 could be of a range of different materials, and the connector assembly 20 could also find uses in a variety of applications other than plumbing.

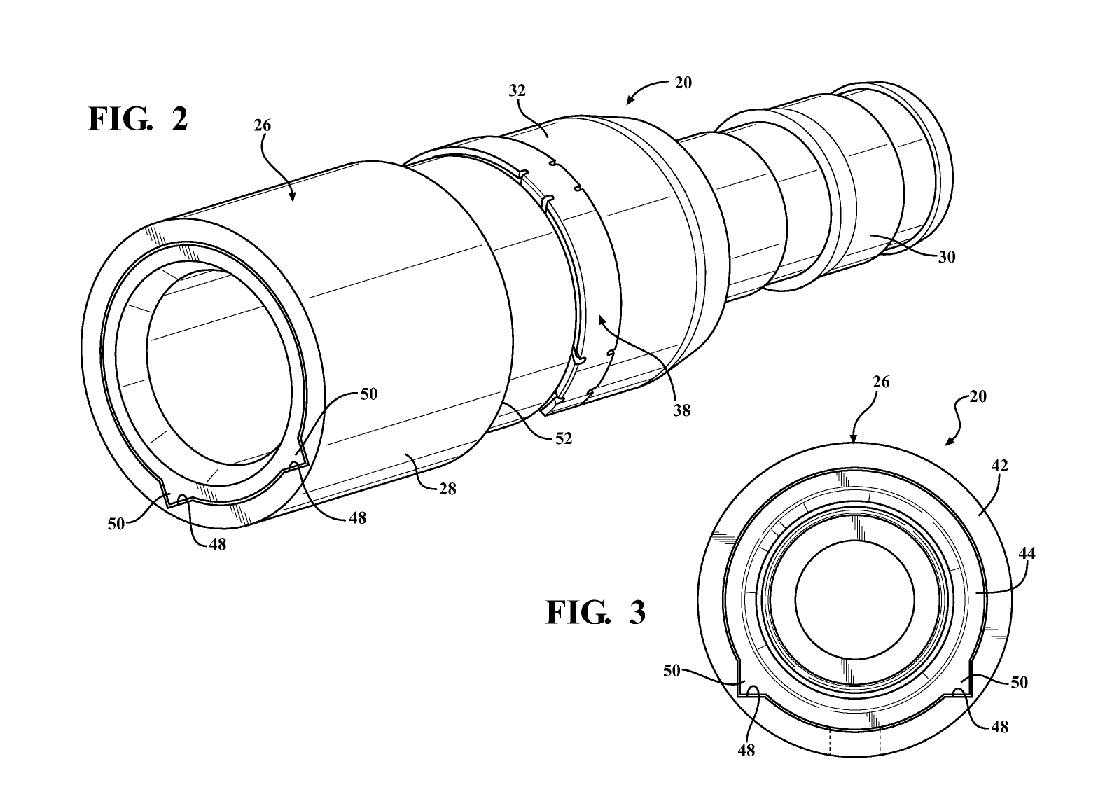

Referring now to FIG. 2, the connector assembly 20 includes a housing 26 which extends along an axis A between a female receiving portion 28 for receiving the copper pipe 22 and a male end form 30 for mating with the PEX tube 24. The male end form 30 is preferably shaped according to ASTM-F-1960 standards for mating with the PEX tube 24 through an expansion fitting process, which will be discussed in further detail below.

The housing 26 additionally includes an intermediate portion 32 which is disposed axially between the female receiving portion 28 and male end form 30. The housing 26 is preferably formed of a polymeric material and shaped through an injection molding process. However, it should be appreciated that the housing 26 could alternately be formed of any suitable material including, for example, metals or composites, and it could be shaped through any desirable process.

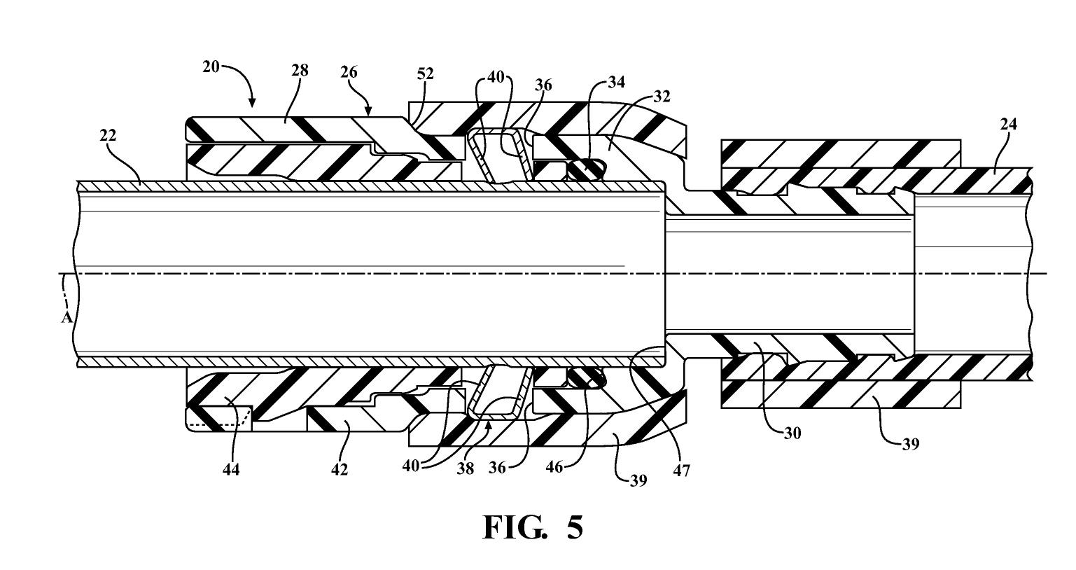

The housing 26 has an exterior surface and an inner bore which extends along the axis A between the female receiving portion 28 and male end form 30 for conveying a fluid between the copper pipe 22 and the PEX tube 24. As shown in FIG. 5, an O-ring seal 34 is disposed in the inner bore for establishing a fluid tight seal between the housing 26 and the copper pipe 22. Referring back to FIG. 2, the housing 26 additionally includes a plurality of circumferentially spaced apertures 36, or windows, which extend radially between the exterior surface and the inner bore. The apertures 36 are preferably disposed axially between the female receiving portion 28 and the O-ring seal 34. The housing 26 could include any desirable number of apertures 36.

The connector assembly 20 additionally includes a retainer 38 having an arcuate, or semi-circular shape, and extending at least partially around the exterior surface of the intermediate portion 32 of the housing 26. The retainer 38 includes a plurality of teeth 40 which extend radially inwardly through the apertures 36 of the housing 26. The retainer 38 of a spring-like material, such as stainless steel, and is deflectable between a non-engaged position with the teeth 40 either retracted from the inner bore or only partially extending into the inner bore and an engaged position (shown in FIG. 5) where the teeth 40 extend radially further into the inner bore of the housing 26 than the non-engaged position. In other words, the teeth 40 of the retainer 38 are pushed further into the inner bore when the retainer 38 is adjusted from the non-engaged position to the engaged position. The retainer 38 is preferably biased into the non-engaged position and moves into the engaged position when an expansion ring 39 and/or the end of the PEX tube 24 is collapsed around the retainer 38, as will be discussed in further detail below. The retainer 38 is preferably formed of stainless steel for cost and corrosion-resistance purposes. However, it should be appreciated that the retainer 38 could be formed of any desirable material having spring-like characteristics.

The process of fluidly connecting the copper pipe 22 and the PEX tube 24 with the connector assembly 20 is described as follows. A user first inserts the copper pipe 22 into the inner bore of the housing 26 through the female receiving portion 28. The copper pipe 22 is inserted in an axial direction past the O-ring seal 34 to establish a fluid-tight seal between the copper pipe 22 and the housing 26. Next, the user uses an expansion tool (not shown) to expand one of the ends of the PEX tube 24 along with at least one PEX expansion ring 39. The end of the PEX tube 24 is then inserted over at least the male end form 30 of the housing 26 and also the intermediate portion 32 of the housing 26, if desired. In either case, at least one PEX expansion ring 39 is inserted over the intermediate portion 32 of the housing 26 such that it covers the retainer 38. The expansion ring 39 then contracts about the retainer 38, thereby forcing the retainer 38 into the engaged position. This urges the teeth 40 of the retainer 38 against the copper pipe 22 and locks the copper pipe 22 into engagement with the connector assembly 20. The contraction of the end of the PEX tube 24 also establishes a fluid-tight seal between itself and the male end form 30 of the housing 26. A second PEX expansion ring 39 may also be included to further improve the seal between the PEX tube 24 and the male end form 30 of the housing 26. With that, fluid communication is established between the copper pipe 22 and the PEX tube 24, and the resulting connection is very strong and resists pull out of either the copper pipe 22 or the PEX tube 24. The process is also very quick and can be accomplished by, for example, a plumber very efficiently without any welding or the use of any adhesives. Although not shown, it should be appreciated that the PEX tube could alternately be inserted over the retainer so that the collapsing of both the PEX tube and the expansion ring force the retainer into the engaged position.

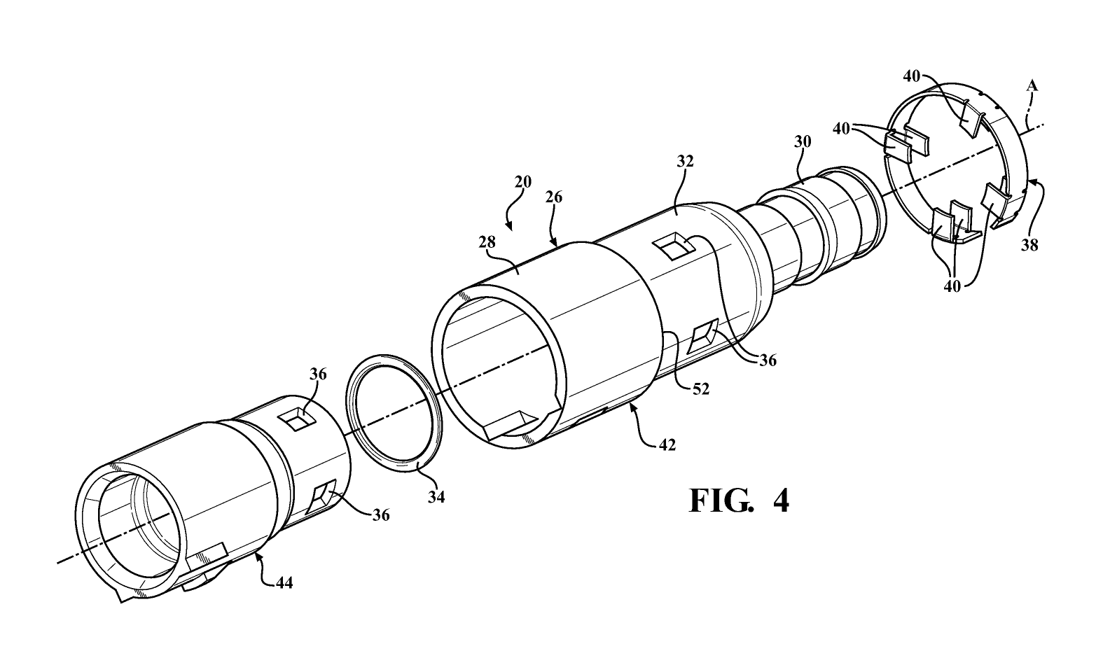

Referring now to the exploded view of FIG. 4, the housing 26 of the exemplary connector assembly 20 is constructed of two pieces including an outer housing portion 42 and an inner housing portion 44, which is nested within the outer housing portion 42. The interior of the outer housing portion 42 is counter-bored to present a first shoulder 46 facing towards the female receiving portion 28 of the housing 26. The end of the inner housing portion 44 is spaced axially from the first shoulder 46 of the outer housing portion 42 to present a ring groove in the inner bore. As shown in FIG. 5, the O-ring seal 34 discussed above for establishing a fluid-tight seal between the copper pipe 22 and the housing 26 is disposed in the ring groove. This two-piece construction of the housing 26 allows for simple assembly of the quick connector assembly 20. For example, the O-ring seal 34 may be inserted into the outer housing portion 42 until it rests against the first shoulder 46 before and outer and inner housing portions 42, 44 are attached together. This process may be quicker and more efficient than what would be required to insert an O-ring seal into the ring groove of a one-piece housing. However, it should be appreciated that the housing 26 could alternately be constructed of any desirable number of pieces. The exemplary outer and inner housing portions 42, 44 are snap-fit together but could alternately be attached to one another through fasteners, adhesives, welding, etc. The exemplary outer housing portion 42 additionally includes a second shoulder 47 spaced from the first shoulder 46 for serving as a stopping point to limit the insertion of the copper pipe 24 into the inner bore of the housing 26. Alternatively, the first shoulder may additionally serve as the stopping point for limiting the insertion of the copper pipe into the inner bore of the housing.

Because of the two-piece construction of the housing 26, each of the outer and inner housing portions 42, 44 must include a plurality of apertures 36, and the apertures 36 must be aligned with one another for the teeth 40 of the retainer 38 to be able to engage the copper pipe 22. In the exemplary embodiment, proper alignment of the apertures 36 of the outer and inner housing portions 42, 44 is ensured through a groove and rib feature between these components. Specifically, the inner surface of the outer housing portion 42 includes a pair of V-shaped grooves 48 which are spaced circumferentially from one another and extend axially from the female receiving portion 28, and the outer surface of the inner housing portion 44 includes a pair of V-shaped ribs 50 which are shaped similarly to the V-shaped grooves 48. The inner housing portion 44 can only be installed into the outer housing portion 42 by aligning the V-shaped ribs 50 with the V-shaped grooves 48, thus ensuring that the inner housing portion 44 is properly oriented relative to the outer housing portion 42. It should be appreciated that the ribs and grooves could have any desirable shape and that the ribs and grooves could be disposed on the opposite components, i.e. the grooves could be disposed on the inner housing portion 44 and the ribs could be disposed on the outer housing portion 42. It should also be appreciated that any suitable non-symmetrical feature could be employed to ensure proper alignment of the inner housing portion 44 relative to the outer housing portion 42.

The outer housing portion 42 additionally presents a third shoulder 52 which extends radially outwardly and faces towards the male end form 30 to define a stopping point for the insertion of the PEX expansion ring 39 onto the housing 26. This ensures that the PEX expansion ring 39 is properly installed onto the housing 26 so that it will collapse around the retainer 38 and force the retainer 38 to the engaged position with the teeth 40 being urged against the copper pipe 22. The outer housing portion 42 could alternately include one or more radially extending tabs for defining the stopping point of the PEX expansion ring 39.

In the exemplary embodiment, the retainer 38 is generally arcuately, or semi-cylindrically, shaped and extends along a length which runs greater than one hundred and eighty degrees (180°) around the circumference of the intermediate portion 32 of the housing 26. The retainer 38 additionally includes a pair of teeth 40 adjacent each of its ends. When the retainer 38 is in the non-engaged position, the teeth 40 at the ends of the retainer 38 cooperate with the housing 26 to prevent complete removal of the retainer 38 from the housing 26. As such, the retainer 38 cannot easily be completely removed from the housing 26.

Additionally, the teeth 40 of the exemplary embodiment are disposed in pairs with the teeth 40 in each pair being spaced axially from one another and the different pairs being spaced circumferentially from one another. Even further, the teeth 40 are preferably angled towards the male end form 30 to provide additional resistance to the copper pipe being pulled out of the housing 26. This unique construction has been found to provide a very strong connection between the housing 26 and the copper pipe 22 without causing damage to the copper pipe 22.

Obviously, many modifications and variations of the present invention are possible in light of the above teachings and may be practiced otherwise than as specifically described while within the scope of the appended claims

What is claimed is:

1. A connector assembly for establishing fluid communication between a pipe and a tube of an expandable material, comprising:
a housing extending along an axis between a female receiving portion for receiving the pipe and a male end form for receiving the tube;
said housing presenting an exterior surface and an inner bore;
said housing presenting at least one aperture extending in a radial direct from said exterior surface to said inner bore; and
a retainer extending at least partially around said perimeter of said exterior surface of said housing and including a plurality of teeth extending radially inwardly into said at least one aperture, and wherein said at retainer is of a spring-like material and is deflectable in a radially inward direction from a non-engaged position to an engaged position for retaining the pipe in said inner bore of said housing in response to an expansion ring contracting about said retainer.

2. The connector assembly as set forth in claim 1 wherein said retainer has a generally arcuate shape and extends at least partially circumferentially around said exterior surface of said housing.

3. The connector assembly as set forth in claim 2 wherein said retainer is of stainless steel.

4. The connector assembly as set forth in claim 2 wherein said retainer extends greater than halfway around said housing, wherein said retainer includes a pair of teeth adjacent each of its ends, and wherein said teeth adjacent said ends of said retainer cooperate with said housing to hold said retainer on said housing when said retainer is in said first position.

5. The connector assembly as set forth in claim 1 wherein said housing includes an intermediate portion disposed axially between said female receiving portion and said male end form.

6. The connector assembly as set forth in claim 5 wherein said retainer extends at least partially circumferentially around said exterior surface of said intermediate portion.

7. The connector assembly as set forth in claim 1 wherein said housing includes an outer housing portion and an inner housing portion disposed within said outer housing portion, and wherein said at least one aperture extends through both of said inner and outer housing portions.

8. The connector assembly as set forth in claim 7 wherein said outer housing portion includes a first shoulder facing towards said female receiving portion, and wherein an end of said inner housing portion is spaced axially from said first shoulder to present a ring groove in said inner bore of said housing.

9. The connector assembly as set forth in claim 8 further including a seal in said ring groove between said inner housing portion and said first shoulder of said outer housing portion for sealing the pipe to said housing.

10. The connector assembly as set forth in claim 9 wherein said seal is an O-ring.

11. The connector assembly as set forth in claim 9 wherein one of said inner and outer housing portions includes at least one notch and the other of said inner and outer housing portions includes at least one rib received within said notch to align said apertures of said inner and outer housing portions.

12. The connector assembly as set forth in claim 11 wherein said outer housing portion includes a plurality of circumferentially spaced notches and wherein said inner housing portion includes a plurality of circumferentially spaced ribs received within said notches.

13. The connector assembly as set forth in claim 12 wherein said notches and ribs are generally V-shaped.

14. A method of establishing fluid communication between a pipe and a tube of an expandable material with a connector assembly having a housing and a retainer with a plurality of teeth, comprising the steps of:
inserting the pipe into one end of the housing;
expanding an end of the tube and at least one expansion ring;
inserting the side of the housing opposite of the pipe into the expanded end of the tube; and
contracting the end of the tube onto the housing and contracting the at least one expansion ring about the retainer to engage the teeth onto the pipe to hold the pipe in the housing.

15. The method as set forth in claim 14 wherein said step of inserting the pipe into one end of the housing is further defined as inserting the pipe into one end of the housing until it abuts a shoulder on the housing.

16. The method as set forth in claim 15 wherein the step of inserting the housing into the expanded end of the tube is further defined as inserting the housing into the expanded end of the tube until the end of the tube abuts a second shoulder on the housing.

17. The method as set forth in claim 14 wherein the pipe is of copper and the tube is of a cross-linked polyethylene (PEX) material.
